(19) United States
(12) Patent Application Publication
(10) Pub. No.: US 2022/0391715 A1
(43) Pub. Date: Dec. 8, 2022

(54) DATA EXTENSION DEVICE, DATA EXTENSION METHOD, AND DATA EXTENSION PROGRAM

(71) Applicant: NIPPON TELEGRAPH AND TELEPHONE CORPORATION, Tokyo (JP)

(72) Inventors: Takahiro HATA, Tokyo (JP); Keisuke TSUNODA, Tokyo (JP); Nobuhiko MATSUURA, Tokyo (JP); Sotaro MAEJIMA, Tokyo (JP)

(73) Assignee: NIPPON TELEGRAPH AND TELEPHONE CORPORATION, Tokyo (JP)

(21) Appl. No.: 17/771,429

(22) PCT Filed: Oct. 25, 2019
(86) PCT No.: PCT/JP2019/041995

§ 371 Date: Apr. 22, 2022

(51) Int. Cl. G06N 5/02

(52) U.S. Cl. CPC G06N 5/022

(57) ABSTRACT

Sufficient data extension can be achieved even if the starting date/time and ending date/time of the learning execution data have been uniquely defined. Based on entire learning data that is a set of time-series data, wherein the entire learning data is a set of minimum constitution unit data, each of which is time-series data having a first time interval that is a time interval required for learning, wherein the time-series data having the first time interval is each assigned a first label that indicates a feature in a time series of the first interval; a generation unit (103) generates learning execution data that is a set of time-series data to be used in learning, by combining the minimum constitution unit data included in the entire learning data such that regularity of the first label in a time series of the entire learning data is maintained.

### TECHNICAL FIELD

The present disclosure relates to a data extension device, a data extension method, and a data extension program.

### BACKGROUND ART

Conventionally, a machine learning technology has been known which automatically learns a feature amount from input data and generates a learner for executing tasks such as motion image and voice recognition and time-series data prediction. The machine learning technology improves task performance by learning a learner using learning data. If the number of learning data is too small, overtraining occurs.

A technique is known which performs data extension for increasing the number of learning data in order to suppress overtraining and improve the generalization performance of the learner (e.g., Non-Patent Literature 1). In Non-Patent Literature 1, for the purpose of predicting the stock price after 30 seconds, data extension for the time-series data of stock buying and selling orders is performed by shifting the starting date/time of sampling for creation of the learning execution data set later for each completion of creation of the learning execution data set. The learning execution data set is a set of learning execution data which is a collection of learning data used by a learner to execute a single task. In an example of Non-Patent Literature 1, for creating a learning execution data set, learning data, which is acquired time-series data of stock buying and selling orders for a period of about several hundred days, is repeatedly sampled at an interval of 30 seconds from a starting date/time to obtain 90-minute data as one learning execution data. Then, the starting date/time of sampling is shifted 10 seconds later, and similar sampling is performed again. Thus, data extension is achieved corresponding to the number of times of shifting although some overlapping is observed between the learning data.

### CITATION LIST

### Non-Patent Literature

Non-Patent Literature 1: Daigo Tashiro and Kiyoshi Izumi “Shinsogakushu to Kouhindochumonjoho ni yoru Kabukadokosuitei (Stock Price Movement Estimation by Deep Learning and High-Frequency Order Information)”, The Japanese Society for Artificial Intelligence, Interest Group on Financial Informatics, the 19th Meeting, 2017.

### SUMMARY OF THE INVENTION

### Technical Problem

In a case where an interval between the starting date/time and the ending date/time of the learning execution data is uniquely defined, sufficient data extension can be achieved by shifting the starting date/time of sampling. However, in a case where the starting date/time and ending date/time of the learning execution data are uniquely defined rather than the interval, there is a problem that sufficient data extension cannot be achieved. For example, in a case where it is uniquely defined that the starting date/time is at 6:00 on a certain day and the ending date/time is at 23:00 on a day three days after the starting date/time, the time interval at which the starting date/time can be shifted is at least 24 hours. Therefore, the number of times of shifting the starting date/time is reduced, and sufficient data extension cannot be achieved.

The disclosed technology is made in view of the above described problem, and an object thereof is to provide a data extension device, a data extension method, and a data extension program which can achieve sufficient data extension even if the starting date/time and ending date/time of the learning execution data have been uniquely defined.

### Means for Solving the Problem

A first aspect of the present disclosure is a data extension method, wherein based on entire learning data that is a set of time-series data, wherein the entire learning data is a set of minimum constitution unit data, each of which is time-series data having a first time interval that is a time interval required for learning, wherein the time-series data having the first time interval is each assigned a first label that indicates a feature in a time series of the first interval; a generation unit generates learning execution data that is a set of time-series data to be used in learning, by combining the minimum constitution unit data included in the entire learning data such that regularity of the first label in a time series of the entire learning data is maintained.

A second aspect of the present disclosure is a data extension device including a generation unit, wherein based on entire learning data that is a set of time-series data, wherein the entire learning data is a set of minimum constitution unit data, each of which is time-series data having a first time interval that is a time interval required for learning, wherein the time-series data having the first time interval is each assigned a first label that indicates a feature in a time series of the first interval; the generation unit generates learning execution data that is a set of time-series data to be used in learning, by combining the minimum constitution unit data included in the entire learning data such that regularity of the first label in a time series of the entire learning data is maintained.

A third aspect of the present disclosure is a data extension program for causing a computer to execute: based on entire learning data that is a set of time-series data, wherein the entire learning data is a set of minimum constitution unit data, each of which is time-series data having a first time interval that is a time interval required for learning, wherein the time-series data having the first time interval is each assigned a first label that indicates a feature in a time series of the first interval; a generation unit generating learning execution data that is a set of time-series data to be used in learning, by combining the minimum constitution unit data included in the entire learning data such that regularity of the first label in a time series of the entire learning data is maintained.

### Effects of the Invention

According to the disclosed technology, sufficient data extension can be achieved even if the starting date/time and ending date/time of the learning execution data have been uniquely defined.

### BRIEF DESCRIPTION OF DRAWINGS

FIG. 1 is a block diagram showing a schematic configuration of a computer that functions as a data extension device.

FIG. 2 is a block diagram showing an example of a functional configuration of a data extension device according to the present embodiment.

FIG. 3 is a diagram showing an example of overall learning data.

FIG. 4 is a diagram showing an example of arrangement of second labels.

FIG. 5 is a diagram showing an example of a combination of patterns.

FIG. 6 is a diagram showing an example of arranging selected minimum constitution unit data.

FIG. 7 is a diagram showing an example of arranging minimum constitution unit data using permutations.

FIG. 8 is a flowchart showing a data extension processing routine of the data extension device according to the present embodiment.

### DESCRIPTION OF EMBODIMENTS

<Configuration of a Data Extension Device According to an Embodiment of the Technology of the Present Disclosure>

Hereinafter, an example embodiment of the disclosed technology will be described with reference to the drawings. In each drawing, the same or equivalent components and parts are given the same reference numerals. Additionally, the dimensional ratios in the drawings are exaggerated for the sake of explanation, and may differ from the actual ratios.

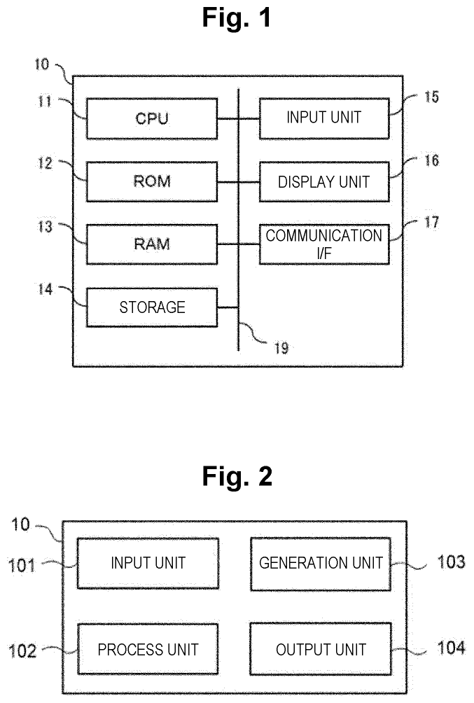

FIG. 1 is a block diagram showing a hardware configuration of a data extension device 10 according to the present embodiment. As shown in FIG. 1, the data extension device 10 includes a CPU (Central Processing Unit) 11, a ROM (Read Only Memory) 12, a RAM (Random Access Memory) 13, a storage 14, an input unit 15, a display unit 16, and a communication interface (I/F) 17. Each component is communicatively connected with each other via a bus 19.

The CPU 11 is a central processing unit which executes various programs and controls various parts. That is, the CPU 11 reads a program from the ROM 12 or the storage 14, and executes the program using the RAM 13 as a work area. The CPU 11 controls the above-described components and performs various arithmetic processing according to a program stored in the ROM 12 or the storage 14. In the present embodiment, the ROM 12 or the storage 14 stores a data extension program for executing data extension processing.

The ROM 12 stores various programs and various data. The RAM 13 temporarily stores programs or data as a work area. The storage 14 includes a storage device such as an HDD (Hard Disk Drive) or SSD (Solid State Drive) which stores various programs including an operating system and various data.

The input unit 15 includes a pointing device such as a mouse, and a keyboard, and is used for various inputs.

The display unit 16 is, for example, a liquid crystal display for displaying various types of information. The display unit 16 may function as the input unit 15 by employing a touch panel system.

The communication interface 17 is an interface for communicating with other equipment, and employs a standard such as Ethernet (R), FDDI, Wi-Fi (R).

Next, a functional configuration of the data extension device 10 will be described. FIG. 2 is a block diagram showing an example of the functional configuration of the data extension device 10. As shown in FIG. 2, the data extension device 10 includes an input unit 101, a process unit 102, a generation unit 103, and an output unit 104 as the functional configuration. Each part of the functional configuration is realized by the CPU 11 reading out a data extension program stored in the ROM 12 or the storage 14 and expanding it in the RAM 13 to execute the program.

In the present disclosure, a case where a task is to predict the number of people observed at a facility will be described as an example. Using learning execution data generated by the data extension device 10 according to the present disclosure, a learner executing the task is made to learn. Learning execution data, which is time-series data used in learning, has a starting date/time and an ending date/time that are uniquely defined. Specifically, it is assumed that the starting time Ts is 0:00 on A-th day and the ending time Te is 24:00 on A+7-th day. That is, the learning execution data is defined as time-series data of the number of people for consecutive 7 days. Further, the sampling time t is set to 1 hour. Among the learning execution data, the previous 6 days are used as input data to the learner, and the last one day is used as teacher data corresponding to output data of the learner.

The input unit 101 receives input of overall learning data which is a set of time-series data for each sampling time t and which is a set of minimum constitution unit data. Here, the minimum constitution unit data is a time-series data having a first time interval that is a time interval required for learning, wherein the time-series data having the first time interval is assigned a first label that indicates a feature in a time series of the first interval.

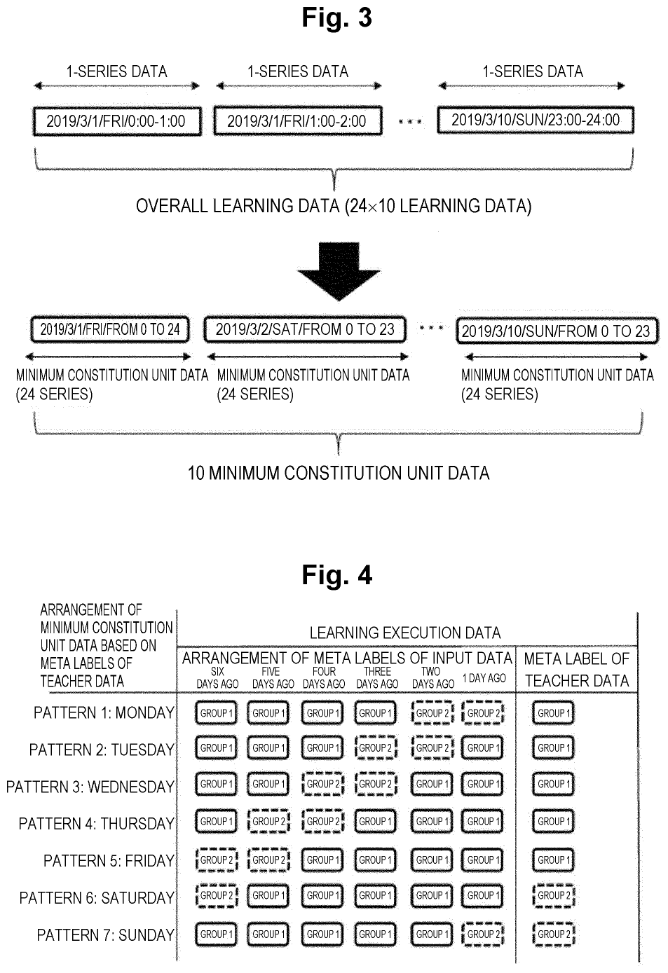

In the present disclosure, a case where the overall learning data is a time-series data obtained with sampling time t for 10 days from 0:00 on Friday, Mar. 1, 2019, to 24:00 on Sunday, Mar. 10, 2019, will be described as an example. Then, if the minimum constitution unit is defined as a 1-day or 24-sampling time series in overall learning data, “A set of 10 minimum constitution unit data=Overall learning data” (FIG. 3). The minimum constitution unit is the smallest data unit required to capture change in time-series data. That is, the minimum constitution unit is a constituent unit of learning data acquired during the first time interval which is the time interval required for learning. It is noted that one day is described as the first time interval in the present disclosure, but the first time interval is not limited to one day and depends on the task to be handled and the learning data.

Seven kinds of “day of week labels”, Monday to Sunday, are defined as first labels indicating features of the minimum constitution units that are time-series data of time intervals. Overall learning data is assumed to be assigned a first label for each minimum constitution unit. A first label may be assigned to each minimum constitution unit for the input overall learning data. Then, the input unit 101 passes the accepted overall learning data to the process unit 102.

The process unit 102 extracts the regularity of the first label based on correlation between a difference series of the minimum constitution unit data and a difference series of the minimum constitution unit data assigned a different kind of first label from that of the respective minimum constitution unit data, with respect to each of the minimum constitution unit data. Then, the process unit 102 assigns a second label to each minimum constitution unit data included in the entire learning data, where the number of kinds of the second labels is smaller than the number of kinds of the first labels.

Specifically, the process unit 102 first computes a correlation coefficient between the difference series of the minimum constitution unit data having different first labels. The difference series is a series of data in which the difference from data separated by one time point is taken, in time-series data. For example, in the case of the overall learning data in this disclosure, when the first labels are combination of any of “Monday” to “Friday”, the combination between difference series of minimum constitution unit data is highly correlated (e.g., correlation coefficient 0.7). However, when the correlation coefficient is calculated using a combination of any of difference series of minimum constitution unit data with the first label “Saturday” or “Sunday” and any of difference series of minimum constitution unit data with the first label “Monday” to “Friday”, the correlation is low (e.g., correlation coefficient 0.3). In addition, in the case where the first labels are a combination of “Saturday” and “Sunday”, when the correlation coefficient is calculated between difference series of the minimum constitution unit data, the correlation is high (e.g., correlation coefficient 0.8). From this, for the first label, regularity can be found that there are two groups within which the correlation coefficient is high: a group of “Monday” to “Friday” and a group of “Saturday” and “Sunday”. Therefore, based on the regularity of the first label, “Monday” to “Friday” of the first label can be clustered into the “Group 1”, and “Saturday” and “Sunday” can be clustered into “Group 2”.

As described above, the process unit 102 assigns the second label “group 1” or the second label “group 2” to each minimum constitution unit data as a meta label based on the correlation between the difference series of the minimum constitution unit data having the first labels. As described above, when a second label is assigned to each minimum constitution unit data of the overall learning data of the present disclosure as described above, 6 minimum constitution unit data are assigned the second label “group 1”, and 4 minimum constitution unit data are assigned the second label “group 2”, By assigning the second label, non-obvious features of the minimum constitution unit data can be visualized.

Then, process unit 102 passes the entire learning data assigned the second label to the generation unit 103.

The generation unit 103 selects the minimum constitution unit data assigned the second label and included in the entire learning data based on regularity of the second label by which the first label has been replaced with the second label, and generates the learning execution data by combining the selected minimum constitution unit data such that the regularity of the second label is maintained.

Here, when focusing on the first label of minimum constitution unit data used for teacher data, the arrangement of the minimum constitution unit data constituting the learning execution data has several patterns depending on the target data. For example, in the learning execution data of the present disclosure, since the sequence of days of week is unique and the number of kinds of the first label is 7, the arrangement of the minimum constitution unit data constituting the learning execution data has 7 patterns. Further, when the arrangement of the minimum constitution unit data is represented using the assigned second label, the arrangement of the minimum constitution unit data constituting the learning execution data also has 7 patterns. For example, if the first label of the minimum constitution unit data which is teacher data is “Monday”, the first label of the six minimum constitution unit data which is input data is “Tuesday” to “Sunday” in order from the previous one. When first labels are replaced with second labels, the arrangement is as shown in pattern 1 of FIG. By repeating the same process, a total of 7 patterns of the arrangement of the second labels for 7 consecutive days are obtained. The generation unit 103 uses the regularity of the second label by which the first label is replaced with the second label, for the obtained 7-pattern arrangement.

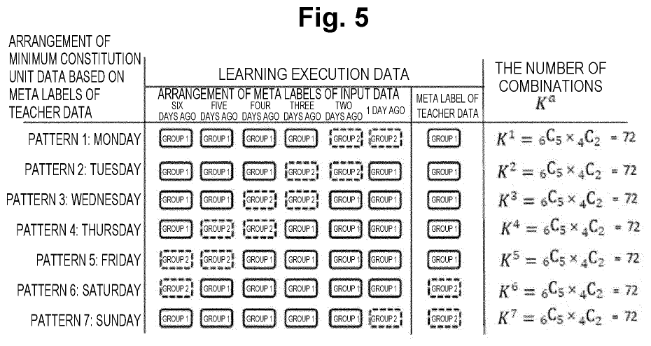

For each pattern “a” (a=1−7), the number of combinations for selecting 10 minimum constitution unit data having second labels from the overall learning data is calculated as shown in FIG. 5. For example, in the pattern 1, five data having the second label “Group 1” and two data having the second label “Group 2” needs to be arranged. On the other hand, in the overall training data, there are six data having the second label “group 1” and four data having the second label “group 2”. The number of combinations K¹ for selecting respective data from them can be calculated as ₆C₅×₄C₂=72.

Next, the generation unit 103 selects the minimum constitution unit data that can be combined for each of all the patterns such that the regularity of the second label is maintained. More specifically, the generation unit 103 selects minimum constitution unit data from 504 combinations, the number of which is obtained by summing the numbers of combinations K¹ to K⁷ for respective patterns (the following equation (1)).

[Math. 1]

D=Σₐ₌₁⁷K^{a}=72×7=504 (1)

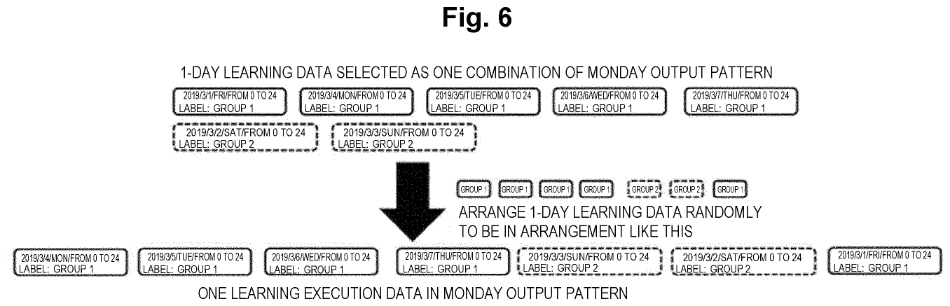

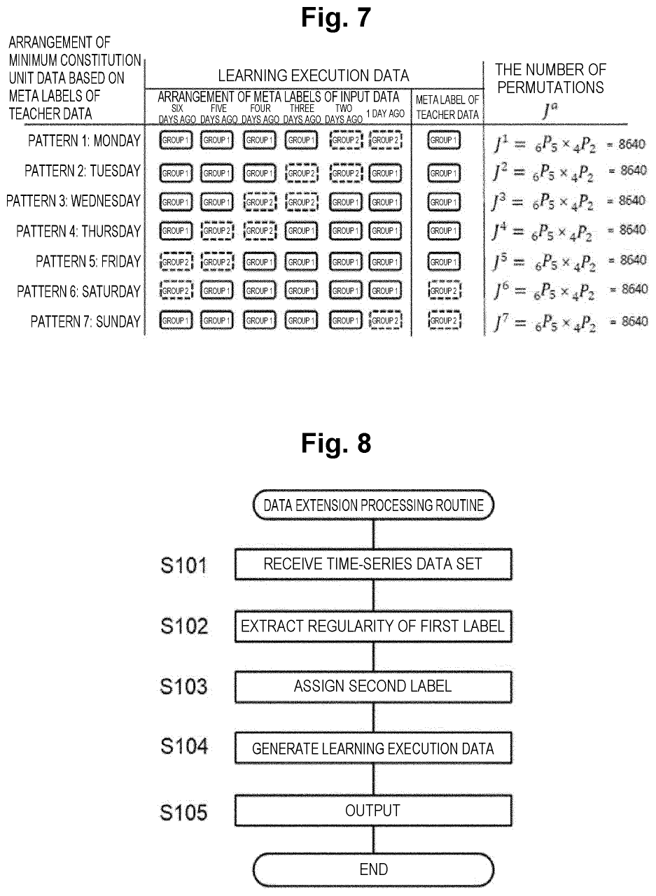

The generation unit 103 generates learning execution data by combining the selected minimum constitution unit data with respect to each of the patterns. At this time, the generation unit 103 randomly sets a sequence in which the minimum constitution unit data constituting one generated learning execution data is arranged within the second label. An example of the case of the pattern 1 will be described with reference to FIG. 6. In the pattern 1, the regularity of the label 2 is “Group 1”, “Group 1”, “Group 1”, “Group 1”, “Group 2”, “Group 2”, “Group 1”. The minimum constitution unit data of the selected five second labels “Group 1” and the minimum constitution unit data of the two second labels “Group 2” are randomly arranged within the second label to generate one learning execution data. In other words, in the regularity of the label 2 for the pattern 1, the minimum constitution unit data of the selected five second labels “Group 1” are randomly arranged in the first four and the last one “Groups 1” which form learning execution data. Similarly, in the regularity of the label 2 for the pattern 1, the minimum constitution unit data of the selected two second labels “Group 2” are randomly arranged in the fifth and sixth “Groups 2” which form learning execution data. In this way, the generation unit 103 generates all combinations (504 in the above example) which can be the learning execution data. The generation unit 103 defines a set of the generated learning execution data as a learning execution data set. It is noted that instead of randomly arranging the minimum constitution unit data for each combination, permutation calculation may be used for arranging the data (FIG. 7). Then, the generation unit 103 passes the generated learning execution data set to the output unit 104.

The output unit 104 outputs the learning execution data set generated by the generation unit 103. The learner is made to learn based on the learning execution data set output by the output unit 104.

<Operation of the Data Extension Device According to the Embodiment of the Technology of the Present Disclosure>

Next, the operation of the data extension device 10 will be described.

FIG. 8 is a flowchart showing a flow of a data extension processing routine by the data extension device 10. The data extension processing routine is performed by the CPU 11 reading out a data extension program from the ROM 12 or the storage 14 and expanding it in the RAM 13 to execute the program.

In step S101, as the input unit 101, the CPU 11 receives input of overall learning data which is a set of time-series data for each sampling time t and which is a set of minimum constitution unit data. Here, the minimum constitution unit data is a time-series data having a first time interval that is a time interval required for learning, wherein the time-series data having the first time interval is assigned a first label that indicates a feature in a time series of the first interval.

In step S102, as the process unit 102, the CPU 11 extracts the regularity of the first label based on correlation between a difference series of the minimum constitution unit data and a difference series of the minimum constitution unit data assigned a different kind of first label from that of the respective minimum constitution unit data, with respect to each of the minimum constitution unit data.

In step S103, as the process unit 102, the CPU 11 assigns a second label to each minimum constitution unit data included in the entire learning data, where the number of kinds of the second labels is smaller than the number of kinds of the first labels.

In step S104, as the generation unit 103, the CPU 11 selects the minimum constitution unit data assigned the second label and included in the entire learning data based on regularity of the second label by which the first label has been replaced with the second label. Then, as the generation unit 103, CPU 11 generates the learning execution data by combining the selected minimum constitution unit data such that the regularity of the second label is maintained.

In step S105, as the output unit 104, CPU 11 outputs the learning execution data and terminates the process.

As described above, the data extension device according to the embodiment of the present disclosure generates, based on entire learning data, learning execution data that is a set of time-series data to be used in learning, by combining minimum constitution unit data included in the entire learning data such that regularity of the first label in a time series of the entire learning data is maintained. Accordingly, sufficient data extension can be achieved even if the starting date/time and ending date/time of the learning execution data have been uniquely defined. Such entire learning data is a set of time-series data, and is a set of minimum constitution unit data. Such minimum constitution unit data is a time-series data having a first time interval that is a time interval required for learning, wherein the time-series data having the first time interval is assigned a first label that indicates a feature in a time series of the first interval.

Further, the regularity of the first label is extracted based on correlation between one minimum constitution unit data and others of the minimum constitution unit data, with respect to each of the minimum constitution unit data, so that non-obvious features of time-series data of the minimum constitution unit data can be used for data extension.

Further, the second label, the number of kinds of which is smaller than that of the first label, is assigned to minimum constitution unit data included in the entire learning data, so that the number of minimum constitution unit data per one kind of the second label can be increased. Thereby, the number of combinations for rearranging minimum constitution unit data can be increased.

The present disclosure is not limited to the above-described embodiments, and various modifications and applications can be made without departing from the gist of the present invention.

The data extension program executed by the CPU reading and executing software (program) in the above-described embodiments may be executed by various processors other than the CPU. Exemplary processors in this case include a PLD (Programmable Logic Device) which can change its circuit configuration after manufacturing, such as FPGA (Field-Programmable Gate Array), and a dedicated electrical circuit which is a processor having a circuit configuration designed exclusively for performing specific processing, such as ASIC (Application Specific Integrated Circuit). The data extension program may be executed by one of these various processors or by a combination of two or more processors of the same or different types (e.g., a plurality of FPGAs, and a combinations of CPU and FPGA, etc.). The hardware structure of these various processors is more specifically an electrical circuit that combines circuit elements such as semiconductor devices.

Further, in the above-described embodiments, a mode in which the data extension program is prestored (installed) in the ROM 12 or the storage 14 has been described, but the program is not limited thereto. The program may be provided in a CD-ROM (Compact Disk Read Only Memory), a DVD-ROM (Digital Versatile Disk Read Only Memory), and a non-transitory storage medium such as a USB (Universal Serial Bus) memory. The program may also be downloaded from an external device via a network.

Regarding the foregoing embodiments, the following supplementary items will be further disclosed.

(Supplementary Item 1)

A data extension device comprising:

a memory; and

at least one processor connected to the memory,

wherein the processor is configured to:

based on entire learning data that is a set of time-series data, wherein the entire learning data is a set of minimum constitution unit data, each of which is time-series data having a first time interval that is a time interval required for learning, wherein the time-series data having the first time interval is each assigned a first label that indicates a feature in a time series of the first interval,

generate learning execution data that is a set of time-series data to be used in learning, by combining the minimum constitution unit data included in the entire learning data such that regularity of the first label in a time series of the entire learning data is maintained.

(Supplementary Item 2)

A non-transitory storage medium having a data extension program stored therein, the data extension program causing a computer to:

based on entire learning data that is a set of time-series data, wherein the entire learning data is a set of minimum constitution unit data, each of which is time-series data having a first time interval that is a time interval required for learning, wherein the time-series data having the first time interval is each assigned a first label that indicates a feature in a time series of the first interval,

generate learning execution data that is a set of time-series data to be used in learning, by combining the minimum constitution unit data included in the entire learning data such that regularity of the first label in a time series of the entire learning data is maintained.

### REFERENCE SIGNS LIST

10 Data extension device
11 CPU
12 ROM
13 RAM
14 Storage
15 Input unit
16 display unit
17 Communication interface
19 Bus
101 Input unit
102 Process unit
103 Generation unit
104 Output unit

1. A data extension method, the method comprising:
generating learning execution data by combining minimum constitution data in learning data so as to maintain regularity of a first label in a time series of the learning data, the learning data including a set of minimum constitution unit data, each minimum constitution unit data including time-series data with a first time interval, the first time interval including a first label, the first label representing a feature associated with the first time interval needed for learning.

2. The data extension method according to claim 1, the method further comprising:
extracting the regularity of the first label based on a correlation between the minimum constitution unit data and each of other minimum constitution unit data in the set of minimum constitution unit data; and
generating the learning execution data by combining the minimum constitution unit data included in the learning data such that the regularity of the first label extracted based on the learning data is maintained.

3. The data extension method according to claim 2, the method further comprising:
assigning a second label to the minimum constitution unit data included in the learning data, wherein a number of types of the second labels is smaller than a number of types of the first labels;
selecting the minimum constitution unit data assigned the second label and included in the learning data based on regularity of the second label by which the first label has been replaced with the second label; and
generating the learning execution data by combining the selected minimum constitution unit data such that the regularity of the second label is maintained.

4. The data extension method according to claim 2, the method further comprising:
extracting the regularity of the first label based on a correlation between a first difference series of the minimum constitution unit data and a second difference series of the minimum constitution unit data with a different type of first label.

5. A data extension device comprising a processor configured to execute a method comprising:
generating learning execution data that by combining minimum constitution unit data in learning data so as to maintain regularity of a first label in a time series of the learning data, is the learning data including a set of minimum constitution unit data, each minimum constitution unit data including time-series data with a first time interval, the first time interval including a first label, the first label representing a feature associated with the first time interval needed for learning.

6. A computer-readable non-transitory recording medium storing computer-executable program instructions that when executed by a processor cause a computer system to execute a method comprising:
generating learning execution data by combining minimum constitution unit data in the learning data so as to maintain regularity of a first label in a time series of the learning data, the learning data including a set of minimum constitution unit data, each minimum constitution unit data including time-series data with a first time interval, the first time interval including a first label, the first label representing a feature associated with the first time interval needed for learning.

7. The data extension device according to claim 5, the processor further configured to execute a method comprising:
extracting the regularity of the first label based on a correlation between the minimum constitution unit data and each of other minimum constitution unit data in the set of minimum constitution unit data; and
generating the learning execution data by combining the minimum constitution unit data included in the learning data such that the regularity of the first label extracted based on the learning data is maintained.

8. The data extension device according to claim 7, the processor further configured to execute a method comprising:
assigning a second label to the minimum constitution unit data included in the learning data, wherein a number of types of the second labels is smaller than a number of types of the first labels;
selecting the minimum constitution unit data assigned the second label and included in the learning data based on regularity of the second label by which the first label has been replaced with the second label; and
generating the learning execution data by combining the selected minimum constitution unit data such that the regularity of the second label is maintained.

9. The data extension device according to claim 7, the processor further configured to execute a method comprising:
extracting the regularity of the first label based on a correlation between a first difference series of the minimum constitution unit data and a second difference series of the minimum constitution unit data with a different type of first label.

10. The computer-readable non-transitory recording medium according to claim 6, the computer-executable program instructions when executed further causing the computer system to execute a method comprising:
extracting the regularity of the first label based on a correlation between the minimum constitution unit data and each of other minimum constitution unit data in the set of minimum constitution unit data; and
generating the learning execution data by combining the minimum constitution unit data included in the learning data such that the regularity of the first label extracted based on the learning data is maintained.

11. The computer-readable non-transitory recording medium according to claim 10, the computer-executable program instructions when executed further causing the computer system to execute a method comprising:
assigning a second label to the minimum constitution unit data included in the learning data, wherein a number of types of the second labels is smaller than a number of types of the first labels;
selecting the minimum constitution unit data assigned the second label and included in the learning data based on regularity of the second label by which the first label has been replaced with the second label; and
generating the learning execution data by combining the selected minimum constitution unit data such that the regularity of the second label is maintained.

12. The computer-readable non-transitory recording medium according to claim 10, the computer-executable program instructions when executed further causing the computer system to execute a method comprising:
extracting the regularity of the first label based on a correlation between a first difference series of the minimum constitution unit data and a second difference series of the minimum constitution unit data with a different type of first label.
